(19) United States
(12) Patent Application Publication
(10) Pub. No.: US 2002/0031495 A1
(43) Pub. Date: Mar. 14, 2002

(54) Pesticidally active isolate of beauveria bassiana, methods of preparing and using same for pest control in agriculture

(76) Inventors: Esperanza Morales, Santafe de Bogota (CO); Werner Knauf, Liederbach (DE); Jorge Mayer, Canberra (AU)

Correspondence Address: William F. Lawrence, Esq., FROMMER LAWRENCE & HAUG LLP, 745 Fifth Avenue, New York, NY, 10151, US

(21) Appl. No.: 09/800,343

(22) Filed: Mar. 6, 2001

Related U.S. Application Data
(63) Continuation of application No. 09/206,850, filed on Dec. 7, 1998, now abandoned.
(60) Provisional application No. 60/083,423, filed on Apr. 29, 1998.

(51) Int. Cl. A01N 63/04

(52) U.S. Cl. 424/93.5

(57) ABSTRACT

A pesticidally active isolate of the fungus Beauveria bassiana, which is monosporic and which may be used in agriculture as a pesticide for the effective control of pests. The biomass of the inventive isolate contains an unusually high proportion of spores. The invention also provides methods for the preparation of the isolate and methods of formulating and using same for the effective control of crop infesting pests.

### CROSS-REFERENCE TO RELATED APPLICATION

This application claims the benefit of U.S. Provisional Application Serial No. 60/083,423, filed Apr. 29, 1998.

### FIELD OF THE INVENTION

The invention is directed to a pesticidally active isolate of the fungus, Beauveria bassiana, and methods of preparing and using same in agriculture for the effective control of crop-infesting pests.

### BACKGROUND OF THE INVENTION

Biological control of pests which plague agricultural production has been the subject of recent interest and attention.

Conventional chemical agents have in some instances become ineffective since certain pests, including various species of insects, have become resistant to them. Also, the use of chemical agents poses potential dangers to the environment, to the agricultural workers who handle the pesticides and the treated crops. Chemical pesticides also present potential hazards to the consumers of the agricultural end products.

As alternatives to chemical pesticides, biological control agents, such as mycoinsectides, are becoming increasingly desirable, since in many instances, they can provide effective control of pests which may have become resistant to traditional chemical agents.

One pest of interest is the sweet potato whifefly. The sweet potato whitefly Bemisia tabaci (Gennadius) has appeared on poinsettias in California, Florida, Georgia and North Carolina. During 1981, the sweet potato whitefly was responsible for crop and market losses of 100 million dollars in cotton, cucurbits and lettuce in California and Arizona. The whitefly is increasingly a problem in Florida where, in 1986, this whitefly caused approximately 2 million dollars of damage to Florida's 8-10 million dollar poinsettia crop.

The sweet potato whitefly is also a pest of international importance, having been found on host plants throughout the mideast Caribbean and Central America. This insect is now known to feed on more than 500 different plants, many of which are of importance in the Caribbean and Florida. For example, cassava, sweet potato, squash, tomato, beans, lettuce, cotton, pepper, carrot, cucumber, eggplant, and water melon are all known hosts. This species of whitefly severely impacts infested plants by its feeding, production of honeydew with resultant growth of sooty mold, and transmission of plant pathogens. Most extensive losses to this pest have been through direct feeding damage and indirect damage through transmission of plant diseases.

Whitefly-borne diseases are of major importance in tropical and subtropical agriculture. More than 70 diseases caused by viruses and microorganisms are known to be transmitted by whiteflies, with most of them being transmitted by the sweet potato whitefly. In Puerto Rico, this whitefly is a vector of at least seven diseases. One of these diseases is the bean golden mosaic virus, a disease affecting many legumes.

The sweet potato whitefly has proven to be very difficult to control with conventional pesticide applications. Many factors contribute to the lack of control obtained with pesticides. The most important factor is that this whitefly has demonstrated a broad spectrum of resistance to chlorinated hydrocarbons, organophosphorus, carbamate, and synthetic pyrethroid insecticides. Very few commercially available pesticides are effective against whiteflies, and those which do work are only effective if care is taken to make a very thorough application of the insecticide several times a week. The sweet potato whitefly spends most of its life on the undersides of leaves, therefore, growers must adjust their management practice to permit increased pesticide coverage there. The spacing of the plants must be such that the chemical spray can penetrate the canopy and reach all surfaces of the plants.

Other pests, including sucking insects, thrips, scrobipalpua, leafminer and coffee borers, Colorado potato beetles, aphids, and also cockroaches, have become increasingly resistant to conventional pesticidal agents.

In the past, although certain pesticides, such as mycoinsecticides, have been developed and utilized, no pesticidal fungus has been identified , which is particularly effective against pests resistant to conventional agents, and wherein the bulk of the fungal mass is comprised of spores, or conidium.

Since fungi initiate pesticidal action by attachment of the germinating spore, or conidium, to the cuticle of the insect host, leading to subsequent infection, it is desirable to obtain a pesticidally effective fungus which has a significantly high proportion of spores as part of its biomass. The presence of an unusually high proportion of spores as part of the fungal biomass would provide a surprisingly concentrated pesticidal agent, having an unusually high level of pesticidal activity, in contrast to any previously known agents.

Additionally, processing of such a fungus, particularly a monosporic fungus, would be expedited since certain purification and preparation steps could be minimized or eliminated.

### OBJECTS AND SUMMARY OF THE INVENTION

It is an object of the invention to provide a virulent isolate of the fungus Beauveria bassiana, which is particularly useful and effective as a pesticide.

It is a particular object of the invention to provide a virulent isolate of pesticidally active fungus which has an unusually high proportion of spores in the fungal biomass.

It is yet a further object of the invention to provide an isolate of monosporic fungus which provides highly concentrated pesticidal effects, including insecticidal effects.

It is still another object of the invention to provide a pesticidally active isolate of fungus which is particularly effective in agriculture against crop infesting insects, including those which have become resistant to conventional pesticidal agents.

It is an additional object of the invention to provide a pesticidally active isolate of fungus whichprovides for the extremely effective control of crop infecting pests, while avoiding or minimizing dangers associated with the use of traditional chemical agents.

It is yet another object of the invention to provide a method of preparing and isolating an isolate of pesticidally active monosporic fungus in which more than half the biomass is comprised of spores.

It is still another object of the invention to provide an effective method of controlling pests in agriculture, which method comprises the application of a pesticidally active isolate of fungus either alone or in combination with other pesticidal agents, and/or carriers, to the pests or to the crops to be protected.

Surprisingly, it has been found that these desirable aims can be achieved by the inventive isolate of Beauveria bassiana.

The isolate according to the invention is further characterized in that the fungal biomass is monosporic and may contain up to about 60% spores.

This fungal isolate is particularly effective as an insecticide, against crop-infesting insect pests, particularly those which have become resistant to conventional pesticidal agents.

### DETAILED DESCRIPTION OF THE INVENTION

It has been discovered that an isolate of Beauveria bassiana (B. Bassiana), which is monosporic and which has a particularly high proportion of spores as part of the biomass, is surprisingly effective as a pesticidal agent, particularly against crop infesting pests, including such insects.

The fungus of the invention is a monosporic strain of Beauveria bassiana, and mutants thereof, which mutants substantially retain the virulence of the parent strain.

The novel isolate of Beauveria bassiana of the subject invention was deposited on Jun. 11, 1998 in the International Depository DSMZ-Deutsche Sammlung von Microorganism und Zellkulturen GmbH, located at Braunschweig, Germany, and has been assigned accession no. DSM 12256, in accordance with the Budapest Treaty.

A biologically pure culture of the novel isolate of Beauveria bassiana of the subject invention will soon be deposited in the American Type Culture Collection (ATCC), 12301 Parklawn Drive, Rockville, Md. 20852.

The subject culture has been and will be deposited under conditions that assure that access to the culture will be available during the pendency of the patent application to one determined by the Commissioner of Patents and Trademarks to be entitled thereto under 37 C.F.R. § 1.14 and 35 U.S.C. § 1.22.

The deposits will be available as required by foreign patent laws in countries wherein counterparts of the subject application, or its progeny, are filed. However, it should be understood that the availability of a deposit does not constitute a license to practice the subject invention in derogation of patent rights granted by governmental action.

This isolate will also be deposited in the USDA—ARS Collection of Entomopathogenic Fungal Culture.

The taxonomic description of the novel Beauveria bassiana is the same as that for other members of B. bassiana. B. bassiana in an imperfect fungus (Fungi Imperfect) of the subdivision Deuteromycotonia. The genus Beauveria Vuill is within the Class Deuteromycetes and is distinguished from other genera by having conidia that are borne singly, not catenulate. The fertile portion of the conidiophore is zigzag in shape and drawn out at the tip. The species B. bassiana has spherical, not ellipsoid, conidia measuring 2 to 3 micrometers by 2 to 2.5 micrometers and with conidiophores forming dense bunches.

Beauveria bassiana, as is the case with most pesticidal fungi, initiates infection by attachment of the germinating spore , or conidium, to the cuticle of an insect host, and subsequent penetration of the cuticle. Invasive hyphae enter the tissue of the insect host and invade the insect's hemocoel. Hyphal bodies or segments of the hyphae move throughout the hemocoel and fill the insect with mycelium. Death of the insect occurs by release of fungal toxins or tissue destruction. Another effect is the reduction of crop damage by a change of feeding behavior, oviposition, and mobility.

Additional infection is caused by hyphae which grow out of the integument of infected insects. These emergent hyphae produce spores on the external surface of the host insect. These spores may then be dispersed and infect new insect hosts.

The mode of infection of Beauveria bassiana is generally by cuticular penetration by the germ tube of the fungal conidia but may also occur through the insect's respiratory and alimentary tracts. Fungal spores may also be voided in the feces and may provide another source of contact with the cuticle of the insect pest.

At least six species of Beauveria are recognized based on morphological and biochemical characteristics: B. alba, B. amorpha, B. bassiana, B. brongniartii, B. velata, and B. Vermiconia (Mugnai et al., 1989, A chemotaxonomic evaluation of the genus Beauveria. Mycol. Res., 92:199-209). Significant differences exist between species of Beauveria, and significant intraspecies variability exist as well. Different strains of B. bassiana are known to exhibit different insecticidal effects. As disclosed by Peczynska-Czoch et al. (Formation of beauvericin by selected strains of Beauveria bassiana 1991. Archivum Immunologiae et Therapiae Experimentalis, 39:175-179), significant intraspecies variability of B. bassiana isolates exist. Ferron (Pest control by the Funghi Beauveria and Metarhizium, In: Microbial Control of Pest and Plant Diseases, 1970-1980, Burges, Ed. 1981, Academic Press, pp. 465-4820) not only discloses that it is known that entomopathogenic fungi have certain specificity, but also discloses that within the same species of fungus different strains can have different activity spectra. Reference is also made to Ferron, Biological Control of Insect Pests by Entomogenous Fungi, 1978, Ann. Rev. Entomol., 23:409-442, which also discloses that different fungal strains have different activity spectrum.

The inventive isolate of Beauveria bassiana differs from other strains of Beauveria, metabolically and biochemically.

However, because (within species) genetic variability is low as compared to interspecific (between species) variability, a combination of several techniques is needed for molecular typing at the strain level (Baleiras Couto et al., 1996). Many loci must be compared until enough polymorphisms have been identified that will be useful in strain characterization.

The inventive isolate of Beauveria bassiana was characterized and discriminated using the polymerase chain reaction (PCR) to amplify variable stretches of the nuclear and of the mitochondrial genome. Primers (reaction initiators), discussed more fully below, used were:

1. Random decanucleotides as used in the “Random Amplified Polymorphic DNA” technique (RAPD) (Williams et al., 1990); 2. Short repetitive sequences (Microsatellites) (Meyer et al., 1991), and 3. Conserved ribosomal gene sequences (White et al, 1990).

1. RAPD Analysis (Williams, 1990): Random decanucleotides (also called 10-mers) were used as primers in the PCR reaction (one at a time). This approach allowed the inventors to amplify stretches of DNA of the microorganism at random, theoretically allowing statistical coverage of the whole genome. Those primers were finally selected that were able to reveal polymorphisms between strains. Polymorphic bands were characterized after electrophoretic separation by their molecular weight, their presence or absence was scored. Only those bands that displayed a strong signal and that were polymorphic were used (this applies for microsatellites, too).

2. Microsatellites (Meyer et al. 1991): Genomes of eukaryotic organisms are interspersed with stretches of repetitive DNA, also called VNTRs (Variable Number Tandem Repcats). Because of relatively low selective pressure on these sequences, intraspecific variability is relatively high, making them good markers for molecular typing of individual strains. Variation in copy number accounts for most of the polymorphisms. The inventors used short oligonucleotides (15 -16 bases long) with repetitive motifs as primers for the PCR reaction. Complex patterns were obtained with (GTG)₅, (CAG)₅, (TCC)₅, (CAC)₅ and M13 (GAG GGT GGN GGN TCT). Other primers, like (GATA)₄, (GACA)₄, (GGAT)₄, (GT)₈, (CA)₈, and (CT)₈ did not produce any bands. Presence or absence of bands was scored and tabulated. Bands were identified by the primer that originated them and their molecular weight.

3. Ribosomal genes (White et al. 1990): Ribosomal genes are located in the nuclear and in the mitochondrial genomes. From work performed in other fungi, conserved regions have been identified that have been used to generate primers that are able to amplify variable regions of the ribosomal genes. One of the most variable regions in the nuclear genes are the ‘Internally Transcribed Spacer” Regions (ITS), and in the mitochondrial genome certain stretches of the structural genes themselves, one region in the large subunit (ML) and one in the small subunit (MS). After amplification with the conserved primers, the amplified fragment is digested with different restriction enzymes to detect polymorphisms derived from mutations. Restriction enzymes used recognize stretches of 4-6 bases and cut the DNA in the case of perfect matches. The cut DNA was separated by agarose gel electrophoresis and band size was scored after staining of gels with ethidium bromide and visualization by UV light. Only those enzymes were used that showed polymorphism in earlier studies. Patterns were catalogued as A, B, . . . etc. Data from the above analyses were tabulated in matrices in the form of ‘1s’ and ‘0s’ for presence or absence of bands respectively.

Another analytical technique used was Hierarchical Clustering and Principal Component Analysis. Clustering is the technique of grouping objects (strains) together that share similar values. It is a multivariate technique that can use any number of variables. The common situation is that data form locally dense areas or clusters in n-dimensional space. Hierarchical clustering or agglomerative clustering starts with each object as its own cluster. At each following step it calculates the distance between each cluster, and combines the two clusters that are closest together, until all points are in one final cluster. The inventors used average linkage for calculating distances, which computes the average distance between pairs of observations, one in each cluster (Sokal and Michener, 1958). The combining record is portrayed as a tree, called a dendrogram, with the single objects as leaves, the final single cluster of all objects as the trunk, and the intermediate cluster combinations as branches.

The presence/absence datapoint matrices can be thought of as a higher-dimensional space (as many dimensions as there are characters, in this case bands). One can take advantage of correlations between objects (strains) to reduce the number of dimensions and be able to analyse data in a two or three-dimensional space. Mathematically this is achieved by principal component analysis (PCA). The first PC is defined as the direction of the linear combination of the variables that has maximum variance. The second PC is defined as the direction of the linear combination of the variables that has maximum variance, subject to being at right angles (orthogonal) to the first PC, and so on. There are as many PCs as there are variables. If there is correlation between the variables, the first few PCs will explain most of the variance. In this case, the first five PCs explain 90% of variance or more.

Both approaches, hierarchical clustering and principal component analysis were performed using the JMP software version 3.2.1 (SAS Institute, 1997).

One can also generate a matrix of distance between strains by using similarity coefficients as those used in numerical taxonomy using qualitative (nominal) data, in this case ‘1s’ for presence of bands and ‘0s’ for its absence. Two widely used coeffecient are the Dice and the Jaccard coefficients (Dice, 1945; Jaccard, 1908).

Dice coefficient: 2a/(2a+b+c)

Jaccard coefficient: a/(n−d)

a, b, c, d are defined as follows for a two-way frequency table for two objects i and j

j

| | | | |
|---|---|---|---|
| i | + | a | b |
| | − | c | d |

a, d . . . matches
b, c . . . unmatches
n = a + b + c + d (total sample size)

### Characterization by Random Amplified Polymorphic DNA (RAPD)

Primers used (name and sequence) for strain characterization (selected from among 50 primers because they revealed polymorphisms between the inventive strain collection and other strains):

| | |
|---|---|
| D-03 | : GTCGCCGTCA |
| C-017: | GTCCCGACGA |
| Q-12 | : AGTAGGGCAC |
| 26-01 | : TACAACGAGG |
| 26-02 | : TGGATTGGTC |
| 26-07 | : TCGATACAGG |
| AB-03: | TGGCGCACAC |
| AB-09: | GGGCGACTAC |
| AB-18: | CTGGCGTGTC |

The inventive strain of fungus identified above is monosporic and has been found to have an unusually high proportion of spores in the fungal biomass, from over about 50% to about 60%, in contast to the proportion found in previously known strains, which is significantly lower.

For example, tests were conducted using the primer OPERON OP-26-5 (5′-GGAATTAATC-3′) for RAPDs (Williams, 1990). Test results demonstrated a new polymorphism, which differentiates the inventive strain (AE101M1) from a known strain ATCC74040. The inventive strain presents a band of 740 of base pairs, which does not appear in the previously known strain ATCC74040 (see FIG. 1 +L).

It has been further discovered that this isolate provides a highly concentrated pesticidal effect, particularly against crop infesting insects which have become resistant to conventional pesticidal agents. Such pests include, but are not limited to, white fly and thrips, sucking insects, scrobipalpua, leafminer, coffee borers, Frank-linea occidentalis, Bemisia tabaci, Bemisia argentifoli, Traleurodes vaporanoium, Colorado potato, beetles, aphids and cockroaches.

The isolate of the invention may be grown on various media such as potato dextrose agar (PDA), Sabourand dextrose agar (SDA), oatmeal agar, and mixed bran agar.

The inventive isolate of Beauveria may be cultured and mass produced by known methods used to cultivate Beauveria, see for example U.S. Pat. No. 4,925,663; Microbial Control of Pests and Plant Diseases 1970-1980, published by Academic Press, pp. 471-473 (1981; edited by H. D. Burges); and Feng et al., J. Invertebrate Pathology, Vol. 46, no. 3, November 1985, page 260, the disclosures of which are incorporated herein by reference. The fungal growth range is between 40 degree(s) and 95 degree(s) F. in a wide range of humidity with high humidity necessary to germinate spores and to increase spore production.

The concentration of the Beauveria bassiana isolate to be applied in practice is surprisingly lower than previously used concentrations, due to the high proportion of spores present in the biomass of the inventive strain.

However, any particular amount to be applied is readily determinable by skilled practitioners, based upon the extent and degree of infestation, the weather, time, Ilife cycle stage of pest, and presence of other pest control agents.

The Beauveria bassiana isolate according to the invention may be applied alone, or it may be applied together with other chemical or biological pesticidal agents including other mycoinsecticidal agents. Other pesticidal agents which may be used, include for example, other entomopathogenic fungi, and also such pesticides as amitraz, deltamethin, and/or endosulfan.

The compositions may applied, either simultaneously or sequentially, with other chemical or biological control agents.

Also, the inventive Beauveria bassiana isolate, either alone or together with other pesticidally active agents, may further be applied in combination with conventional agriculturally acceptable carriers.

Solid and liquid formulations, including oil formulations, may be used. Additional expedients used in the art, such as emulsifiers, thickeners, foaming agents, etc, may be used. For example, examples of wetting agents and dispersants which may be used include sodium olelymethyltauride (®ARKOPON T, ®HOSTAPON T), sodium methoxylignosulfonate (®VANISPESSE CB), sodium lignosulfonate (®BOSSERPERSE), a sodium dinaphthylmethanedisulfonate (®DISPERSOGEN A, ®TAMOL NNO), sodium dibutylnapthalenesulfonate (®FERNIL DB, ®GEROPON NK), sodium polycarboxylate (®SOPROPON T36), long-chain olefin sulfonates (®HOSTAPUR OSB), isotridecanol polyglycol ether (®GENAPOL X-Marten) and polyoxyethylene sorbitan monolaurate (®TWEEN 20).

Other compounds that can be employed as protective substance are glucose, fructose, lactose or sucrose, ultrapure cellulose (®TECNOCEL consists of cellulose), and antioxidant substances such as, for example, ascorbic acid. These compounds may be employed, inter alia, to prevent desiccation of the microorganism. Thus, other compounds, which cause this effect, may also be employed as protective substances.

Preferable fillers for the preparation of the compositions according to the invention are ultra-purified magnesium silicates and aluminum silicates such as, ®BENTONE EW, ®BENTNITE 7c, finely-ground kaolins and clays, ®PERLITE, ®SANTENTONE, ®KAOLIN 1777, and Attapulgus Clay products (e.g., ®ATTACLAY, ®ATTACOTE, ®ATTAGEL, ®CLARSOL FgN-FR4 or ®KIESELGUHR).

The fungal composition may be applied by means of standard agricultural equipment, such as ground spreaders or sprayers, or may be applied aerially.

### BIOLOGICAL EXAMPLES

### Example 1

### Ovicide and Nymphicide Test of Bemisia tabaci

The plants used for the assay were Phaseolus vulgaris, variety ICA-Pijao, 25 days after germination, with only one trifolio to prevent individuals from failing because of leaf friction and to have an appropriate distribution of layings.

For the ovipositions, 2000 adults of Bemisia tabaci, taken at random from a rearing were released in infestation boxes containing 15 of such plants each. After 24 hours the plants were removed without the adults and placed in laboratory, under artificial light. (temperature and relative humidity fluctuations were 20 to 28° C. and 75 to 95% respectively). The total number of eggs per plant was registered with a microscope-stereoscope.

Suspensions of the inventive strain (AE101M1) and known strain ATCC74040 with 1×10⁷ spores/ml were applied 5 days after oviposition with a microsprayer-nebulizer for 4 seconds on each trifolio, which guaranteed a good coverage. The plants were then placed in nylon cages of 2.0 m long×2.0 m wide×1.5 m high in the open air. During the assay procedure, the temperature and relative humidity inside the cages were registered with a hygrothermograph.

The evaluations to determine the effect are as follows:

| | | Evaluation |
|---|---|---|
| | Development stage at the | after application |
| Effect | moment of evaluation | (time in days) |
| Initial evaluation | Eggs of 5 DAO⁽¹⁾, 2 DBE⁽²⁾ | 0 |
| Ovicide | Nymph of first instar | 5 |
| Nymphicide | Adults | 21 |

⁽¹⁾DAO: Days After Oviposition,
⁽²⁾DBE: Days Before Eclosion,
(3) The evaluation of adults was represented by the exuviae left by them, adhered to the underside of the leaf, at the moment of emergence.

To determine the ovicide effect of the strains, every trifolio was evaluated 5 DAA with a stereoscope, counting each uneclosioned egg and the chorions left by the nymphae after emergenced. The chorions, adhered on the leaf, are recognized by the deflated form and by the opening for the nymph to go out.

The nymphicide effect was determined at the end of the assay, 21 DAA, by cutting the trifolio of each treatment. The trifolio was evaluated with the help of a nylon lattice of 1.0 cm² with a stereoscope, counting each dead nymphae and exuviae. Exuviae are the rests of the pupae, adhered on the underside of the leaf, left when the adults emerge. The exuviae provide information about the survival of nymphae.

Six untreated plants were used to determine the natural mortality with which the mortality in the treatments was adjusted by the Henderson and Tilton's formula.

$$H \& T FORMULA \text{:} \% MORTALITY = \frac{1 - ( UNTR . BEFORE * TREATM . AFTER )}{UNTRA . AFTER * TREATM . BEFORE} * 100$$

UNTR.BEFORE=live insects in the untreated before application

TREATM.AFTER=live insects in the treatment after application

UNTR.BEFORE=live insects in the untreatment before application

TREATM.AFTER=live insects in the treatment after application

Tables of results after spraying inventive strain AE101M1 and ATCC74040 on eggs 5 DAO⁽¹⁾ (2 DBE⁽²⁾ of Bemisia tabaci

TABLE 1a
Untreated

| | 0 DBA⁽³⁾ | | | |
|---|---|---|---|---|
| | Initial | 5 Days After Application (DAA⁽⁴⁾) | | |
| Repetition | number | Number of eggs | | Mortality of eggs⁽⁵⁾ |
| (Trifolio) | of eggs | uneclosioned | eclosioned | (%) |
| 1 | 144 | 2 | 140 | 2.8 |
| 2 | 302 | 3 | 295 | 2.3 |
| 3 | 127 | 2 | 125 | 1.6 |
| 4 | 57 | 2 | 53 | 7.0 |
| 5 | 73 | 3 | 69 | 5.5 |
| 6 | 26 | 1 | 24 | 7.7 |
| TOTAL | 729 | 13 | 706 | 3.2 |

| | |
|---|---|
| Average ± SD | 4.5 ± 2.6 |

TABLE 1b
AE101M1 - inventive strain

| | 0 DBA⁽³⁾ | | | |
|---|---|---|---|---|
| | Initial | 5 Days After Application (DAA⁽⁴⁾) | | |
| Repetition | number | Number of eggs | | Mortality of eggs⁽⁵⁾ |
| (Trifolio) | of eggs | uneclosioned | eclosioned | (%) |
| 1 | 572 | 1 | 561 | 3.7 |
| 2 | 73 | 5 | 66 | 9.6 |
| 3 | 323 | 4 | 310 | 4.0 |
| 4 | 218 | 3 | 208 | 4.6 |
| 5 | 120 | 3 | 112 | 6.7 |
| 6 | 171 | 6 | 159 | 7.0 |
| TOTAL | 1477 | 22 | 1406 | 4.8 |

| | |
|---|---|
| Average ± SD | 5.9 ± 2.3 |

TABLE 1c
ATCC 74040

| | 0 DBA⁽³⁾ | | | |
|---|---|---|---|---|
| | Initial | 5 Days After Application (DAA⁽⁴⁾) | | |
| Repetition | number | Number of eggs | | Mortality of eggs⁽⁵⁾ |
| (Trifolio) | of eggs | uneclosioned | eclosioned | (%) |
| 1 | 150 | 3 | 145 | 3.3 |
| 2 | 38 | 2 | 35 | 7.9 |
| 3 | 126 | 4 | 120 | 4.8 |
| 4 | 54 | 5 | 49 | 9.3 |
| 5 | 90 | 3 | 85 | 5.6 |
| 6 | 140 | 1 | 137 | 2.1 |
| TOTAL | 598 | 18 | 571 | 4.5 |

| | |
|---|---|
| Average ± SD | 5.5 ± 2.7 |

⁽¹⁾DAO = Days After Oviposition
⁽²⁾DBE = Days Before Eclosion
⁽³⁾DBA = Days Before Aplication
⁽⁴⁾DAA = Days After Aplication
⁽⁵⁾Included eggs uneclosioned and fallen

Tables of results after spraying inventive strain AE101M1 and ATCC74040 on eggs 5 DAO⁽¹⁾ (2 DBE⁽²⁾ of Bemisia tabaci

TABLE 2a
Untreated

| | 0 DBA⁽³⁾ | 21 Days After Application (DAA⁽⁴⁾) | | |
|---|---|---|---|---|
| | Initial | Number of | | |
| Repetition | number | dead | | |
| (Trifolio) | of eggs | nymphae | exuviae | Mortality of nymphae⁽⁵⁾ |
| 1 | 144 | 0 | 114 | 20.8 |
| 2 | 302 | 3 | 290 | 4.0 |
| 3 | 127 | 0 | 98 | 22.8 |
| 4 | 57 | 0 | 52 | 8.8 |
| 5 | 73 | 0 | 58 | 20.5 |
| 6 | 26 | 0 | 24 | 7.7 |
| TOTAL | 729 | 3 | 636 | 12.8 |

| | |
|---|---|
| Average ± SD | 14.1 ± 8.2 |

TABLE 2b
AE101M1 - inventive strain

| | |
|---|---|
| 0 DBA⁽³⁾ | 21 Days After Application (DAA⁽⁴⁾) |

| | Initial | Number of | | |
|---|---|---|---|---|
| Repetition | number | dead | | |
| (Trifolio) | of eggs | nymphae | exuviae | Mortality of nymphae⁽⁵⁾ |
| 1 | 572 | 1 | 7 | 98.8 |
| 2 | 73 | 0 | 8 | 89.0 |
| 3 | 323 | 0 | 1 | 99.7 |
| 4 | 218 | 4 | 2 | 99.1 |
| 5 | 120 | 3 | 5 | 95.8 |
| 6 | 171 | 2 | 8 | 95.3 |
| TOTAL | 1477 | 10 | 31 | 97.9 |

| | |
|---|---|
| Average ± SD | 96.3 ± 4.0 |

TABLE 2c
ATCC 74040

| | 0 DBA⁽³⁾ | 21 Days After Application (DAA⁽⁴⁾) | | |
|---|---|---|---|---|
| | Initial | Number of | | |
| Repetition | number | dead | | |
| (Trifolio) | of eggs | nymphae | exuviae | Mortality of nymphae⁽⁵⁾ |
| 1 | 150 | 32 | 17 | 88.7 |
| 2 | 38 | 25 | 13 | 65.8 |
| 3 | 126 | 98 | 23 | 81.7 |
| 4 | 54 | 33 | 16 | 70.4 |
| 5 | 90 | 7 | 6 | 93.3 |
| 6 | 140 | 86 | 11 | 92.1 |
| TOTAL | 598 | 281 | 86 | 85.6 |

| | |
|---|---|
| Average ± SD | 82.0 ± 11.6 |

⁽¹⁾DAO = Days After Oviposition
⁽²⁾DBE = Days Before Eclosion
⁽³⁾DBA = Days Before Aplication
⁽⁴⁾DAA = Days After Aplication
⁽⁵⁾Included nymphae dead and fallen

[chemical structure]

As can be seen from the results reported in the foregoing tables, the inventive strain of Beauveria bassiana provides a surprisingly superior insecticidal effect, i.e., 97.6% mortality, in contrast to to the results provided by the known strain, only, i.e., 83.5%.

### Example 2

### Control of Trialeurodes vaporariorum with Beaveria bassiana AE101M1 (Inventive Strain) in Phaseolus vulgaris (Green Bean) under Field Condition

1. General

1.1 Location:

Altitude: 1,700 m.a.s.l.

Precipitation: Average during experimentation period: 100 mm/month.

Temperature:

Average 24° C.

Max: 29° C.

Min.: 16° C.

Relative humidity: Average during experimentation period: 70%

1.2 Crop: Green Bean (P. vulgaris) Variety Blue Lake

Sowing distance: 1.3 m between furrows, 0.4 m between plants

Characteristics:

120 days cultivation period

A growing guide is used

Direct sowing

2. Trial Methodology:

2.1 Design: R.B.D. (Randomized Block Design), with three replications.

2.2 Experimental lot

Experimental lot: 2140 m² with 4116 plants, divided in 0 experimental plots.

Experimental unit: 101.92 m² with 196 plants.

Effective plot: 21.84 m² with 42 plants.

Sampling Unit: 1 square inch

2.3 Applications

2.3.1 Application equipment

Knapsack Sprayer Calimax® (Retained Previous pressure)

Nozzle Devalon HC 3-70, discharge 225 ml/min (Nebulization)

2.3.2. Application mode: On the underside of the leaf.

2.3.3. Application criteria: Presence of dark egg (2-4 days before eclosion) stage population by monitoring.

2.4 Sampling:

It was carried out by selecting 10 plants at random from the effective plot, taking one foliole per plant and observing it in laboratory under the stereoscope (destructive sampling).

For determining the initial population, the samples were taken from the level of the plant with the highest probability of having the dark egg stage (band with the higher growth of folial area).

For determining the efficacy of the treatments, the samples were taken from the band of the plant where the treatments were applied.

In each case, the folioles were of a similar age. Those taken for initial population count were of newer leaves. Those taken for treatment evaluation were of older leaves.

The distribution of immature stages in the foliole was not uniform. It presented a higher concentration around the central nervure. The place selected for square inch for stereoscope or magnifying glass observation, was one of the two quadrants nearest to the base of the foliole, on the equatorial line of the quadrant, next to the nervure.

2.5 Monitoring:

Checked the area with the highest probability to present N 1 population, twice per week, according to the vertical distribution of the different stadiums of the insect. At dark egg stadium, a randomized sampling of 10 folioles per replication were taken and counted under the stereoscope in the laboratory. This was the initial population before treatment application.

2.6 Efficacy evaluation:

At the moment of application, a counting was carried out in order to estimate the initial total population, which was used as a co-variable in the statistical analysis.

28 days after application, the counting of exuviae per square inch was carried out under the stereoscope. These residual cuticles left by nymphae N 4 when becoming adults arean indicator of the survival of the nymph. Therefore, the best treatments were those which showed a lower number of exuviae/in²

2.7 Methods of statistical analysis

For the statistical analysis of exuviae data it was necessary to make the following transformations: (Y+05)^{½} and log(1+Y)

The initial observation of N1 population density was used as a co-variable

Calculating the efficacy (%) according HENDERSON and TILTON

$$\% Efficacy = ( 1 - \frac{Ta \times Ub}{Tb \times Ua} ) \times 100$$

Ub=number of individuals in the untreated plot before treatment

Tb=number of individuals in the treated plot before treatment

Ua=number of individuals in the untreated plot after treatment

Ta=number of individuals in the untreated plot after treatment

4. Treatments

| Nr. | Treatment | Dose Lha. |
|---|---|---|
| 1 | UNTREATED | 0 |
| 2 | AE101M1 (invention) | 1.0 L |
| 3 | ATCC 74040 | 0.8 L |

[chemical structure]

5. Results

Calculating the efficacy (%) according to HENDERSON and TILTON FOR THE INVENTIVE STRAIN AE101M1

$$\% Efficacy = ( 1 - \frac{134 \times 1858}{2413 \times 1162} ) \times 100 = 91.12 \%$$

Calculating the efficacy (%) according to HENDERSON and TILTON FOR ATCC 74040

$$\% Efficacy = ( 1 - \frac{306 \times 1858}{1210 \times 1162} ) \times 100 = 59.56 \%$$

Thus the inventive strain provides a significantly superior efficacy of 91.12% in contrast to the 59.56% efficacy provided by the known strain.

### Example 3

### Conidiospores Productivity of the Inventive (AE101M1) Beauveria bassiana Strain

5×10⁵ conidiospores/ml of Beauveria bassiana AE101M1 and ATCC 74040 strains were inoculated on to the surface of different media. The plates were incubated at 27° C. for seven days in the dark. The spores were harvested from each medium and suspended in a flask with distilled sterile water plus Tween 20 (0.05%). This conidial suspension was blended for one minute to loose the conidia on water. A 1/10 or 1/100 dilution was performed and the conidia counted directly in a hemocitometer. The assess conidial production four counts were done for each flask and the quantity of conidia produced by liter of nutritive media was calculated. It is important to note that three series of tests were done for all experiements.

Beauveria bassiana strain AE101M1 of the invention produced a number at least ten times higher of condidiospores by liter of medium than ATCC 74040 on different culture media (see following Graph No. 1).

The better conidiospores productivity demonstrated by the inventive strain AE101M1 represents a very significant advantage in terms of lower production costs at industrial scale.

[chemical structure]

The foregoing is intended to illustrate the invention without imposing any limitation on the scope of the claimed invention. Various changes in the details, materials and arrangment of parts which have been described and illustrated herein in order to explain the nature of the invention, may be made by those of skill in the art within the principle and scope of the invention as expressed in the appended claims.

What is claimed is:

1. A pesticidally active isolate of the fungus Beauveria bassiana.

2. A pesticidally active monosporic isolate of the fungus Beauveria bassiana which has an unusually high proportion of spores as part of the fungal biomass.

3. A pestcidally active monosporic isolate of the fungus Beauveria bassiana which has from over about 50% to about 60% of spores as part of the fungal biomass.

4. The pesticidally active isolate of claim 1, which provides effective control of pests.

5. The pesticidally active isolate of claim 3 which provides effective control of pests which have become resistant to conventional pesticidal agents.

6. The pesticidal composition which comprises the isolate of claim 1.

7. The pesticidal composition of claim 6 which further comprises an additional pesiticidally active agent.

8. The pesticidal composition of claim 7 wherein the additional pesticidally active agent is selected from the group consisting of entomopathogenic fungi.

9. The pesticidal composition of claim 6 which further comprises a pesticidally active agent selected from the group consisting of amitraz, deltamethrin, and endosulfan.

10. A method for controlling pests, which method comprises application of a composition which comprises the pesticidally active isolate of claim 1, directly to the pests, to the area infested by the pests, or to the area sought to be protected from the pests.

11. The method of claim 10 wherein the composition to be applied further comprises an additional pesticidally active agent selected from the group consising of entomopathogenic fungi.

12. The method of claim 10 wherein the composition to be applied further comprises a pesticidally active agent selected from the group consisting of amitraz, deltamethrin, and endosulfan.

13. The method of claim 10, wherein the pests are selected from the group consisting of whitefly and thrips.

14. A method for controlling a targeted pest, which method comprises applying a composition comprising the pesticidally active isolate of claim 1, directly to the pest, the foliage of plants, or the soil around plants.

15. The method of claim 14, wherein the targeted pest is selected from the group consisting of whitefly and thrips.

16. A pesticidally active isolate of the fungus Beauveria bassiana which has been assigned DSM Accession No. 12256.

17. A pesticidally active monosporic isolate of the fungus Beauveria bassiana which has been assigned DSM Accession No. 12256 which has an unusually high proportion of spores as part of the fungal biomass.

18. A pestcidally active monosporic isolate of the fungus Beauveria bassiana which has been assigned DSM Accession No. 12256 which has from over about 50% to about 60% of spores as part of the fungal biomass.

19. The pesticidally active isolate of claim 16, which provides effective control of pests.

20. The pesticidally active isolate of claim 18 which provides effective control of pests which have become resistant to conventional pesticidal agents.

21. The pesticidal composition which comprises the isolate of claim 16.

22. The pesticidal composition of claim 21 which further comprises an additional pesiticidally active agent.

23. The pesticidal composition of claim 22 wherein the additional pesticidally active agent is selected from the group consisting of entomopathogenic fungi.

24. The pesticidal composition of claim 21 which further comprises a pesticidally active agent selected from the group consisting of amitraz, deltamethrin, and endosulfan.

25. A method for controlling pests, which method comprises application of a composition which comprises the pesticidally active isolate of claim 16, directly to the pests, to the area infested by the pests, or to the area sought to be protected from the pests.

26. The method of claim 25 wherein the composition to be applied further comprises an additional pesticidally active agent selected from the group consising of entomopathogenic fungi.

27. The method of claim 25 wherein the composition to be applied further comprises a pesticidally active agent selected from the group consisting of amitraz, deltamethrin, and endosulfan.

28. The method of claim 25, wherein the pests are selected from the group consisting of whitefly and thrips.

29. A method for controlling a targeted pest, which method comprises applying a composition comprising the pesticidally active isolate of claim 16, directly to the pest, the foliage of plants, or the soil around plants.

30. The method of claim 29, wherein the targeted pest is selected from the group consisting of whitefly and thrips.
